(19) United States
(12) Patent Application Publication
(10) Pub. No.: US 2026/0305815 A1
(43) Pub. Date: Oct. 8, 2026

(54) Adjustable wide waist belt connecting tray for mess-free eating

(71) Applicant: Mandley Jesse Jean Louis, Columbus, OH (US)

(72) Inventor: Mandley Jesse Jean Louis, Columbus, OH (US)

(21) Appl. No.: 19/172,327

(22) Filed: Apr. 7, 2025

(51) Int. Cl. A47B 23/00; A45F 3/14; F16M 13/04

(52) U.S. Cl. CPC A47B 23/002; A45F 3/14; A47B 23/001; F16M 13/04; A45F 2003/144

(57) ABSTRACT

Embodiments of the present disclosure may include an adjustable wide waist belt connecting tray apparatus, offering an innovative solution for enhancing the dining experience, particularly for individuals enjoying food while seated on a couch, bed, or any other settings. The apparatus comprises a tray securely positioned beneath the user's mouth, using a stretchable belt worn around the waist, connected to a pliable stick. This unique design allows users to consume snacks or meals without the concern of spills or crumbs. Additionally, in some embodiments, the tray features deep surfaces and corners strategically designed to capture and retain crumbs, preventing them from falling off during use. With its integrated support structure and foldable design, the apparatus offers stability, convenience, and ease of storage.

### FIELD OF THE INVENTION

The present invention pertains to dining & everyday accessories, particularly addressing the challenges encountered while enjoying meals in relaxed settings such as couches or beds. The invention focuses on enhancing convenience and cleanliness during food consumption. By employing a stretchable belt worn around the user's waist, coupled with a pliable stick, the invention securely positions a tray beneath the user's mouth. This unique configuration offers a practical solution for preventing spills and crumbs by ensuring the tray remains stable during use. Furthermore, in certain embodiments, the tray is equipped with deep surfaces and corners to effectively capture crumbs, enhancing cleanliness. The adjustable wide waist belt connecting tray apparatus introduces an innovative approach to dining & everyday accessories, delivering convenience, hassle-free, and user-friendly design for an enhanced dining experience across diverse settings.

### BACKGROUND

Consuming meals or snacks while seated on a couch or bed often leads to spills and crumbs, creating a need for frequent cleaning. Traditional dining setups lack practical solutions to prevent these messes, particularly in relaxed settings where individuals may multitask or have limited mobility. Additionally, the challenges faced by individuals with varying body types further exacerbate the issue of maintaining cleanliness during snack or mealtime.

Traditional cleaning methods, such as vacuum cleaners, often fall short in effectively addressing the challenges posed by spills and crumbs during food consumption on couches or beds. While vacuum cleaners can remove larger debris, they struggle with smaller particles and may not provide thorough cleaning in tight spaces or fabric surfaces. Moreover, the hassle of setting up and maneuvering a vacuum cleaner detracts from the convenience desired during mealtime relaxation.

Furthermore, individuals often prefer to avoid the hassle of cleaning altogether, opting for solutions that prevent messes in the first place. The inconvenience of post-meal cleanup can deter individuals from enjoying snacks or meals in relaxed settings, leading to a preference for dining solutions that minimize the need for extensive cleaning.

To address these prevalent challenges, the adjustable wide waist belt connecting tray apparatus was developed. This innovative solution revolutionizes the dining experience by securely positioning a tray beneath the user's mouth, using a stretchable belt worn around the lumbar waist, connected to a pliable stick. This unique configuration ensures stability and prevents spills and crumbs, allowing users to enjoy their food without worrying about messes.

Moreover, the invention's incorporation of deep surfaces and corners in the tray design effectively captures crumbs, further enhancing cleanliness during use. By providing a practical and efficient solution, the apparatus caters to the diverse needs of users, including those with limited mobility or individuals seeking convenience while dining in various relaxed settings.

In summary, the adjustable wide waist belt connecting tray apparatus addresses the longstanding challenges associated with food consumption in relaxed or public environments, offering a novel approach to dining & everyday accessories that prioritizes convenience, hassle-free, and cleanliness for an improved dining experience.

### BRIEF SUMMARY OF THE INVENTION

Embodiments of the present disclosure may include the adjustable wide waist belt connecting tray apparatus, an innovative solution designed to revolutionize the snacking and dining experience, particularly for individuals enjoying food while seated on a couch, bed, or any other settings. The apparatus consists of a tray securely positioned beneath the user's mouth, using a stretchable belt worn around the waist, connected to a pliable stick. This unique configuration allows users to indulge in snacks or meals without the worry of spills or crumbs. Additionally, in some embodiments, the tray features deep surfaces and corners to effectively capture and retain crumbs, further enhancing cleanliness during use. With its integrated support structure and foldable design, the apparatus offers stability, convenience, and ease of storage.

### BRIEF DESCRIPTION OF THE FIGURES

Some embodiments of the present invention are illustrated as an example and are not limited by the figures of the accompanying drawings, in which like references may indicate similar elements and in which:

FIG. 1 illustrates a side view of one example of an adjustable wide waist belt connecting tray apparatus, according to some embodiments of the present disclosure.

FIG. 2 illustrates a perspective view of one example of an adjustable wide waist belt connecting tray apparatus, according to some embodiments of the present disclosure.

FIG. 3 further illustrates a rear view of one example of an adjustable wide waist belt connecting tray apparatus, according to some embodiments of the present disclosure.

FIG. 4 further illustrates a front view of one example of an adjustable wide waist belt connecting tray apparatus, according to some embodiments of the present disclosure.

FIG. 5 further illustrates a top view of one example of an adjustable wide waist belt connecting tray apparatus, according to some embodiments of the present disclosure.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “include” and/or “including,” when used in this specification, specify the presence of stated features, elements, and/or components, but do not preclude the presence or addition of one or more features, steps, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present disclosure is to be considered as an exemplification of the invention and is not intended to limit the invention to the specific embodiments illustrated by the figures or description below.

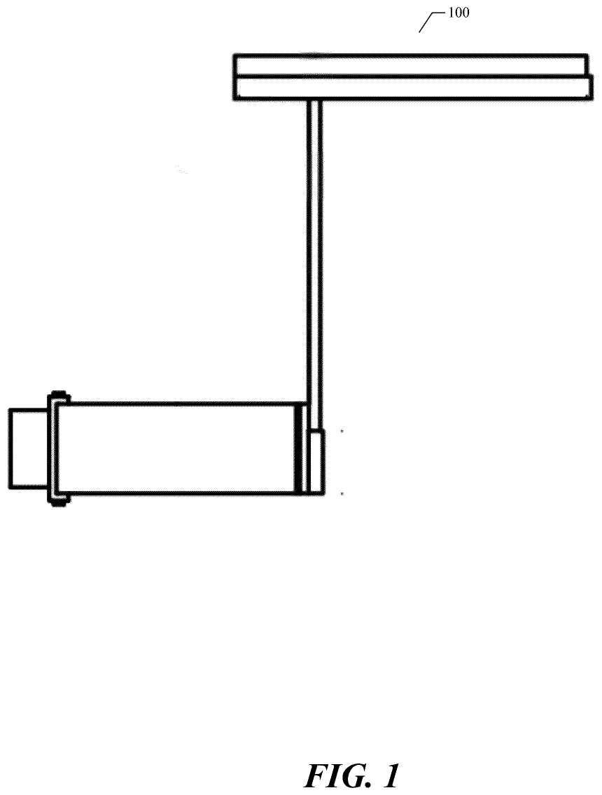

The present invention will now be described by referencing the appended figures representing preferred embodiments. FIG. 1 describes a side view of an adjustable wide waist belt connecting tray 100, according to some embodiments of the present disclosure.

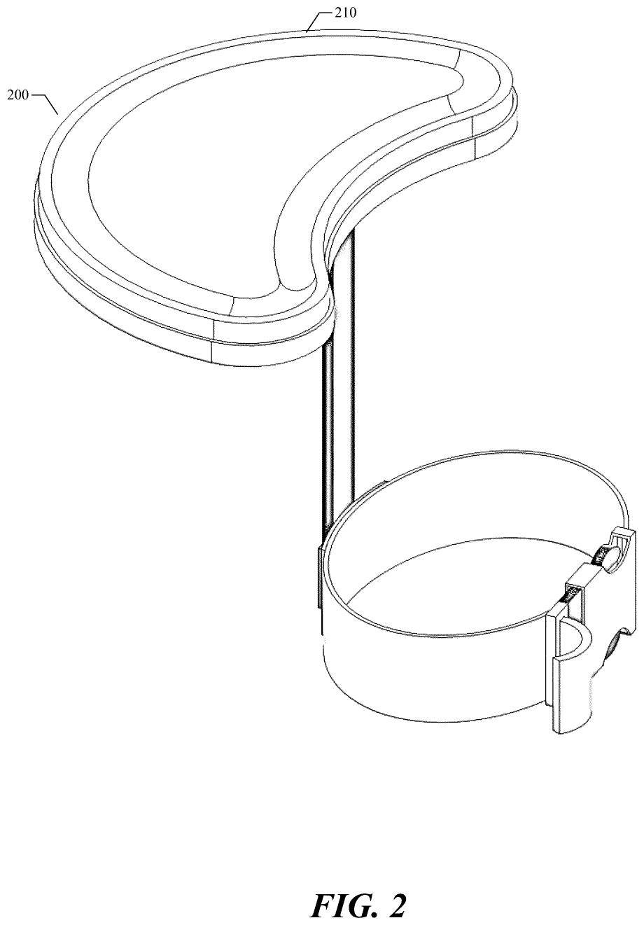

FIG. 2 describes an adjustable wide waist belt connecting tray apparatus 200, according to some embodiments of the present disclosure. In some embodiments, the adjustable wide waist belt connecting tray apparatus 200 may include a tray 210 securely affixed via a pliable stick. The stick may be pliable to accommodate various positions when eating. In some embodiments, the adjustable wide waist belt connecting tray apparatus 200 may also include a tray with deep surfaces and corners designed to capture and retain crumbs, preventing them from falling off during use.

In some embodiments, the belt may be constructed of a flexible material capable of stretching to fit different waist sizes. In some embodiments, the adjustable wide waist belt connecting tray apparatus 200 may include a detachable mechanism facilitating tray removal from the base. In some embodiments, the adjustable wide waist belt connecting tray apparatus 200 may include a foldable configuration for convenient storage and portability.

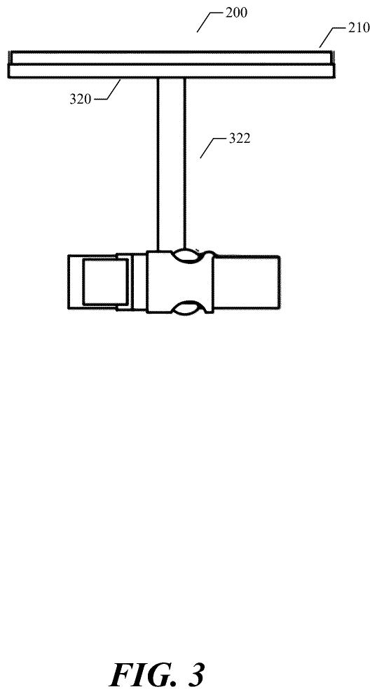

FIG. 3 describes an adjustable wide waist belt connecting tray apparatus 200 from FIG. 2. In some embodiments, the adjustable wide waist belt connecting tray apparatus 200 may include a kidney shaped base 320 for the tray 210, wherein said base 320 is connected to the pliable stick 322.

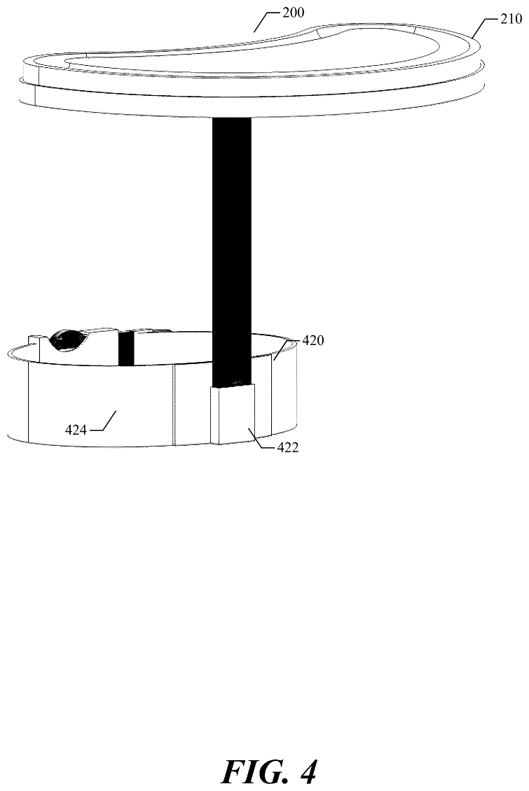

FIG. 4 describes an adjustable wide waist belt connecting tray apparatus 200 from FIG. 2, according to some embodiments of the present disclosure. In some embodiments, an adjustable wide waist belt connecting tray apparatus 200 may include a support structure 420 positioned in front of the belt 424 to provide stability and balance to the tray 210. The support structure 420 may include a metallic base 422 for enhanced stability.

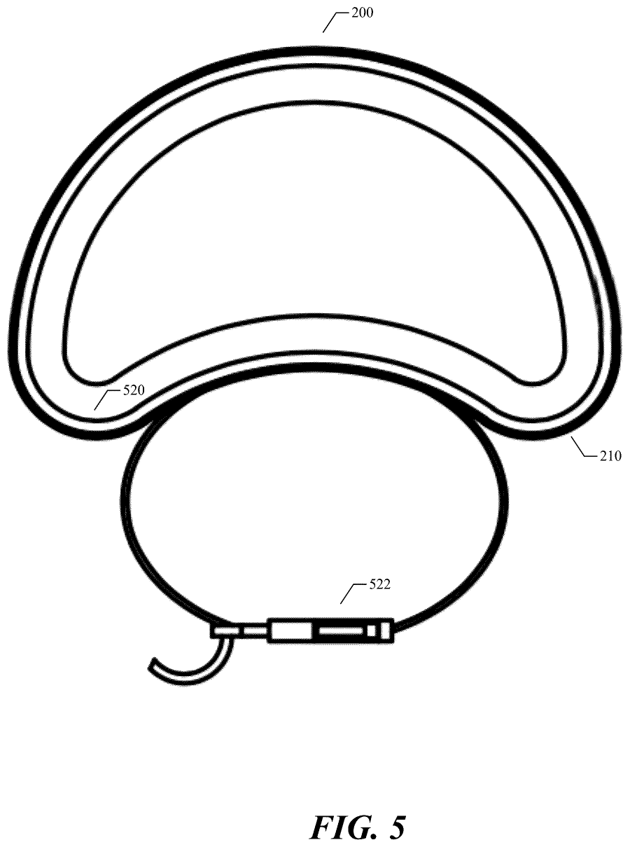

FIG. 5 further describes an adjustable wide waist belt connecting tray apparatus 200 from FIG. 2, according to some embodiments of the present disclosure. In some embodiments, an adjustable wide waist belt connecting tray apparatus 200 may include a tray 210 with deep surfaces and corners 520 designed to capture and retain crumbs, preventing them from falling off during use.

In some embodiments, the adjustable wide waist belt connecting tray apparatus 200 may include a belt with a coupling mechanism such as a buckle 532 for attachment. The mechanism may encompass any means for secure fastening.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An adjustable wide waist belt connecting tray apparatus comprising:
a) a tray securely affixed via a stick, wherein said stick is pliable to accommodate various positions when eating.

2. The adjustable wide waist belt connecting tray apparatus of claim 1, further comprising:
b) a tray with deep surfaces and corners designed to capture and retain crumbs, preventing them from falling off during use.

3. The adjustable wide waist belt connecting tray apparatus of claim 1, further comprising:
c) a belt with a coupling mechanism such as a buckle for attachment, wherein said mechanism encompasses any means for secure fastening.

4. The adjustable wide waist belt connecting tray apparatus of claim 1, wherein:
d) the belt is constructed of a flexible material capable of stretching to fit any waist sizes.

5. The adjustable wide waist belt connecting tray apparatus of claim 1, incorporating:
e) a base for the tray, wherein said base includes any shape suitable for support.

6. The adjustable wide waist belt connecting tray apparatus of claim 1, further comprising:
f) a detachable mechanism facilitating tray removal from the base.

7. The adjustable wide waist belt connecting tray apparatus of claim 1, further comprising:
g) a support structure positioned in front of the belt to provide stability and balance to the tray, wherein said support structure may include a metallic base or any other suitable material for enhanced stability.

8. The adjustable wide waist belt connecting tray apparatus of claim 1, wherein:
h) both the tray walls and stick length are customizable to accommodate user needs.

9. The adjustable wide waist belt connecting tray apparatus of claim 1, further comprising:
i) a foldable configuration for convenient storage and portability.
